(19) United States
(12) Patent Application Publication
(10) Pub. No.: US 2002/0040512 A1
(43) Pub. Date: Apr. 11, 2002

(54) Heated windshield wiper

(76) Inventor: Steven Washington, Dolton, IL (US)

Correspondence Address: Matthew J. Peirce, Esq., 1550 Starlight Canyon Avenue, Las Vegas, NV, 89123, US

(21) Appl. No.: 09/975,641

(22) Filed: Oct. 10, 2001

Related U.S. Application Data
(60) Provisional application No. 60/238,686, filed on Oct. 10, 2000.

(51) Int. Cl. B60S 1/38

(52) U.S. Cl. 15/250.07; 15/250.44; 219/202

(57) ABSTRACT

A new and improved windshield wiper system is disclosed which includes a heating mechanism that heats each windshield wiper in order to prevent a buildup of ice and snow in freezing weather. The heating mechanism includes a set of heating coils that would be attached to the base of each windshield wiper in between the connecting rod and the blade of each windshield wiper. The heating coils would be attached to the top surface of blade to prevent any scratching or other damage to the front windshield. The heating coils of the heating mechanism would be attached to a power means, which would preferably be the battery of the vehicle to which the present invention would be attached.

### I. BACKGROUND OF THE INVENTION

The present invention is that of a new and improved windshield wiper system which includes a heating mechanism that heats each windshield wiper in order to prevent a buildup of ice and snow in freezing weather.

### II. DESCRIPTION OF THE PRIOR ART

U.S. Pat. No. 4,670,933, issued to Toplenszky, discloses an electrically heated windshield wiper assembly which includes a wiper blade of a resilient material.

U.S. Pat. No. 4,497,083, issued to Nielsen, Jr., et al, discloses a heated windshield wiper which has resistance wiring running along the length of the wiper arm, the blade carrier, and the wiper blade for heating the blade and carrier when connected into a vehicle electrical system.

U.S. Pat. No. 4,360,941, issued to Mabie, discloses a windshield wiper assembly for preventing freezing of the wiper blades, and blade supporting frames, of a vehicle, during a sleet storm, the blade and frame being enclosed in the weather protective hood.

### III. SUMMARY OF THE INVENTION

The present invention is that of a new and improved windshield wiper system which includes a heating mechanism that heats each windshield wiper in order to prevent a buildup of ice and snow in freezing weather. The heating mechanism includes a set of heating coils that would be attached to the base of each windshield wiper in between the connecting rod and the blade of each windshield wiper. The heating coils would be attached to the top surface of blade to prevent any scratching or other damage to the front windshield. The heating coils of the heating mechanism would be attached to a power means, which would preferably be the battery of the vehicle to which the present invention would be attached.

There has thus been outlined, rather broadly, the more important features of a windshield wiper system in order that the detailed description thereof that follows may be better understood and in order that the present contribution to the art may be better appreciated. There are, of course, additional features of the windshield wiper system that will be described hereinafter and which will form the subject matter of the claims appended hereto.

In this respect, before explaining at least one embodiment of the windshield wiper system in detail, it is to be understood that the windshield wiper system is not limited in its application to the details of construction and to the arrangements of the components set forth in the following description or illustrated in the drawings. The windshield wiper system is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present windshield wiper system. It is important, therefore, that the claims be regard as including such equivalent constructions insofar as they do not depart from the spirit and scope of the present invention.

It is therefore an object of the present invention to provide a windshield wiper system which has all of the advantages of the prior art and none of the disadvantages.

It is another object of the present invention to provide a windshield wiper system which may be easily and efficiently manufactured and marketed.

It is another object of the present invention to provide a windshield wiper system which is of durable and reliable construction.

It is yet another object of the present invention to provide a windshield wiper system which is economically affordable and available to the buying public.

It is yet another object of the present invention to provide a windshield wiper system which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows the present invention in use.

### V. DESCRIPTION OF THE PREFERRED EMBODIMENT

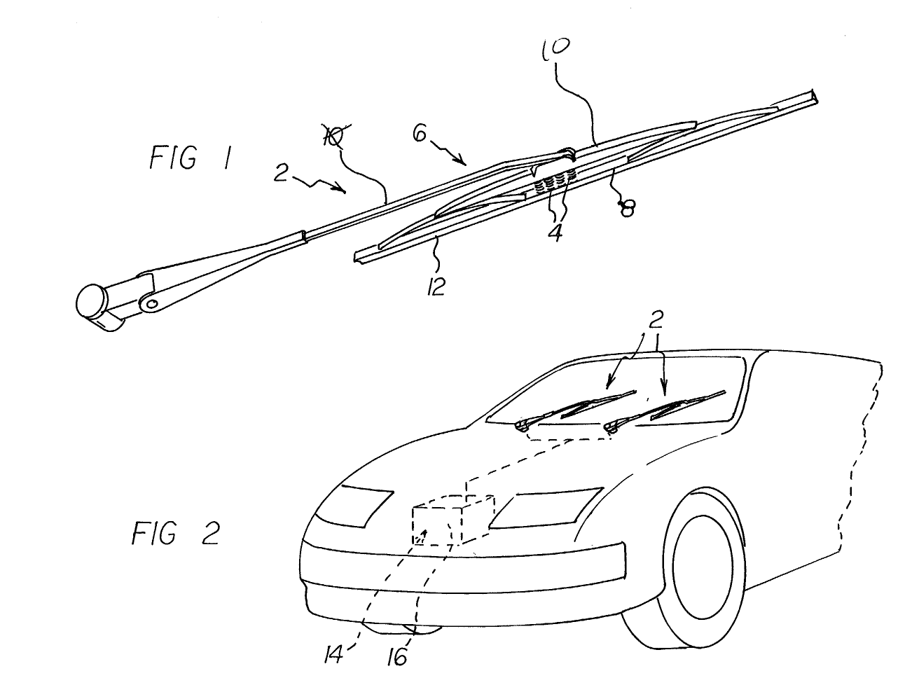

FIG. 1 shows a perspective view of the present invention. The present invention is that of a new and improved windshield wiper system 2 which includes a set of heating coils 4 that heats each windshield wiper 6 in order to prevent a buildup of ice and snow in freezing weather. The heating coils 4 would be attached to the base 8 of each windshield wiper 6 in between the connecting rod 10 and the blade 12 of each windshield wiper 6. The heating coils 4 would be attached to the top surface of each blade 12 to prevent any scratching or other damage to the front windshield. The heating coils 4 would be electronically connected to a power means 14, which would preferably be the battery 16 of the vehicle to which the present invention would be attached.

FIG. 2 shows the present invention in use. Each connecting rod 10 would be pivotally connected to the base of the windshield of the vehicle.

What I claim as my invention is:

1. A windshield wiper system comprising:
(a) a pair of windshield wipers, a first windshield wiper and a second windshield wiper, each windshield wiper having a base, each windshield wiper further including a blade, each windshield wiper further including at least one connecting rod, the connecting rod having two ends, a first end and a second end, the first end of the connecting rod connected to the base, and the second end of the connecting rod connected to the blade,
(b) at least two sets of heating coils, a first set of heating coils and a second set of heating coils, the first set of heating coils connected to the connecting rod on the first pair of windshield wipers, the first set of heating coils further connected to the blade on the first pair of windshield wipers, the second set of heating coils connected to the connecting rod on the first pair of windshield wipers, the second set of heating coils further connected to the blade on the first pair of windshield wipers, and
(c) power means to provide power to all the sets of heating coils.

2. A windshield wiper system according to claim 1 in combination with a vehicle, the vehicle including a battery.

3. A windshield wiper system according to claim 2 wherein the power means comprises the battery and electric wiring connecting the battery to the sets of heating coils.

4. A windshield wiper system according to claim 1 wherein each set of heating coils would comprise at least two heating coils.
